(19) United States
(12) Patent Application Publication
(10) Pub. No.: US 2009/0284361 A1
(43) Pub. Date: Nov. 19, 2009

(54) Driver scoring system with lane changing detection and warning system

(76) Inventors: John Boddie, Singapore (SG); Arcot Jagannath Chandra Sehkhar, Bangalore (IN)

Correspondence Address: George R. Schultz;Schultz & Associates, P.C., One Lincoln Centre, 5400 LBJ Freeway, Suite 1200, Dallas, TX, 75240, US

(21) Appl. No.: 12/152,957

(22) Filed: May 19, 2008

(51) Int. Cl. B60Q 1/00

(52) U.S. Cl. 340/439

(57) ABSTRACT

The invention disclosed provides a driver monitoring and scoring system that detects and alerts the driver of erratic movements in order to redirect the attention of the driver so the driver can correct the poor driving. The system has the capability to record the instances of driving behavior and report them either immediately via a wireless network or from stored memory. The invention also displays a scoring system where the driver loses points for erratic driving and gains points for problem free driving. The system can maintain a list of high scores sorted by driver such that the driver can strive for higher scores resulting in better driving habits. The system can be used in the vehicle of the general public or in specific cases such as monitoring of drunk driving repeat offenders or in commercial vehicles such as school buses and public transportation.

### FIELD OF THE INVENTION

The present invention relates to the field of monitoring and scoring driver dynamics. In particular, the invention relates to a system of sensors and displays that detect and alert the driver of when the driven automobile or other road going vehicle drifts between marked lanes on a freeway or interstate or otherwise demonstrates dangerous or erratic driving behavior.

### BACKGROUND OF THE INVENTION

A vehicle traveling at interstate or highway speeds that unbeknownst to the driver drifts between lanes or demonstrates other erratic or poor driving puts not only the life of the driver and his passengers in danger, but also jeopardizes drivers and passengers of other vehicles sharing the road. The poor driving can be a result of driving under the influence of a substance; driver falling asleep at the wheel; weather or road conditions; driver distraction due to cellular phone, media player, or noise; or simply an inexperienced driver. A driver of a vehicle would benefit greatly if a visual and audible alert could serve to notify the driver when erratic driving occurs, refocus the driver's attention before an incident takes place, and score and keep track of driving performance. The general public would also benefit greatly if a record of the driving habits of public transportation, school buses, or repeat driving under the influence offenders could be recorded and wirelessly transmitted to a remote monitoring station.

Typical of the prior art is U.S. Pat. No. 7,222,690 to Isaji, et al. Isaji discloses a system for monitoring the “awakening degree” of a driver during a driving operation. The “awakening degree” is a measure of the “sleepiness” of a driver. Isaji discloses monitoring various sensors such as steering sensors, accelerator pedal sensors and brake pedal sensors and also monitoring a laser radar sensor which gives range to vehicles ahead. Asaji further discloses that the awakening degree can be ascertained by the variation of certain states of the driving operations determined from monitoring the sensors. Software in the system looks for deviations over time that are above or below an average input from the sensors. Although the reference discloses monitoring driver inputs to measure the sleepiness of the driver, it does not disclose scoring driver performance.

U.S. Pat. No. 7,149,653 to Bihler, et al. discloses a driving system monitoring computer which routinely checks data regarding various vehicle sensors and a “driver observation” system comprised of a microphone and video camera aimed at the driver. The Bihler invention discloses a system which separates sensor inputs into two “states”. The first state comprises data from the sensors when the driver is actively participating in a driving function such as steering, accelerating or braking. The second state comprises data from the sensors when the driver is in a state of distraction, such as when the driver is controlling comfort systems or entertainment systems. The controller of the system then toggles between the first state data and the second state data to determine the behavior of the driver. In the second state, the device is capable of taking over driving functions, such as steering, braking or deceleration. The reference discloses determining driver behavior and taking over driver functions but does not disclose calculating a score based on driver performance.

U.S. Pat. No. 7,079,927 to Tano, et al. discloses a driver monitoring system which compares two locus of points. The first is an idealized combination of data points derived from steering operations and acceleration operations considered as normal driving. The second is a measured set of data points from the sensors. The first set is compared against the second set to determine if an unreasonable driving condition exists. Data related to driving behavior is then recorded on a memory card which can be used at a later time to evaluate a driver. The system discloses capturing and saving driver behavior information, but does not provide for real time scoring and alerting of driver performance.

U.S. Pat. No. 5,642,093 to Kinoshita discloses a warning system for vehicles. It provides at least two cameras on the right and left of the vehicle to provide a view of the lanes ahead and lane detection. The reference also discloses a warning system to alert the driver to specific problems. The reference also discloses the use of various sensors, including acceleration, braking and sensors. The reference further discloses various equations which calculate deviations from a rate of curvature and inequalities which indicate eminent collisions with moving or stationary objects. The system monitors the variation of ranges and steering angles to determine a driver's wakefulness. When this occurs, an alarm signal is given to the driver, such as through an audible alarm or vibration generator in a manner to alert the driver to the hazardous condition created. The reference discloses monitoring a driver's actions and the surrounding area to alert the driver to eminent accidents, but it does not disclose calculating a score in real time that monitors driver performance.

U.S. Pat. No. 6,441,901 to Hiwatashi discloses a device which judges the possibility of lane deviation and warns the driver with an audible warning unit. The reference discloses an image processor which uses CCV cameras and image recognition features to determine lane deviation. The main feature of this reference is a timing device which provides for a persistent alarm after a lane deviation. Although the system alerts drivers to lane deviations, it does not disclose a real-time driver performance scoring system and a history of stored scores.

### SUMMARY OF INVENTION

The present invention discloses a method and apparatus for a driver scoring system coupled with a vehicle monitoring system that affixes two sensor units, one on either side of a vehicle, that scan for and detect lane markers on the road surface. The sensor units are mounted on the vehicle underbody either through attachment to the rails that run along the lateral underside of the vehicle or under the front bumper in front of each front tire. Each sensor unit is comprised of three sensors and a controller. The sensor unit is tuned to look down for lane detection. The sensor unit may look outward at an angle of less than 45 degrees in order to visualize a region 1 to 2 feet to the side of the vehicle. The first sensor of the sensor unit is a CMOS integrated circuit, an electric light sensor charge coupled device (CCD), an infrared sensor (IR sensor), or a reflective color sensor. The second and third sensors are an ambient light sensor and a distance sensor. Each sensor unit is assembled on a single PCB circuit board with the sensors either mounted on the PCB or connected through harness cables. The sensor units are enclosed in a plastics enclosure and the whole unit is adhered to the underside of the vehicle. The sensitivity of the system is a function of ambient light intensity and the distance of the sensor from the road. The controller adjusts the sensitivity of the system.

The invention also includes a user interface mounted inside the cabin of a vehicle to be monitored. The user interface includes a processor, data storage, a display screen, and the capability of providing visual and audible alerts. In an alternate embodiment, a seat vibrator is can be used to alert the driver. The user interface is mounted within reach, within view, and within earshot of the driver. An alternate embodiment of the user interface includes a wireless transmitter that sends driver performance data and scores to a remote monitoring station.

The connection between the sensor units and the user interface is wired or can be wireless. In the case of a wired connection between the sensor units and the user interface, the user interface is powered by connecting to the cigarette lighter or any other 12V DC source in the vehicle and the sensor units are powered by virtue of the wired connection between the sensor units and the user interface. In the case of a wireless connection between the sensor units and the user interface, the user interface is powered by connection to a 12V DC source in the vehicle, and the sensor units incorporate standard disposable or rechargeable batteries.

The processor will timestamp incoming data from each sensor unit to determine driving events and send the data to memory. The processor will score the data over preset time intervals to measure driver performance. The data can be reported and shown on the display screen. The data can also be wirelessly transmitted to a remote monitoring station to alert others of the driving performance. The processor will further use event data to reward or deduct points from a 100 point scale during single driving periods and create driving reports. The data storage can store a driving report and individual scores of many individual drivers.

The display screen displays arrows indicating improving performance trends or declining performance trends and displays current points for the current driving period. The screen may also display the points scored for each event, total points scored, and average performance score which can be sorted by driver.

Lane detection process is as follows. The lane marker is detected in the first sensor. The first sensor is the sensor mounted on either side of the vehicle which detects a lane marker first. The information is sent to the controller and processed. The controller counts one “event” in the first sensor and starts a timer. If neither sensor detects a lane marker within a preset length of time after the event, an alert is registered indicating the vehicle is between lanes. If the second sensor detects the lane marker within a preset length of time, the first event is marked as a complete lane change and a second timer starts. If several lane changes are completed within a preset short length of time and the car is traveling at a speed greater than a minimum threshold speed, then an alert is registered indicating dangerous driving. If the first sensor detects a lane marker again without the second sensor detecting the lane marker, then a counter records a first drift event. If the number of drift events exceeds a preset limit, an alert is registered indicating lane drifting. Further functions of the system include, if a lane change is completed and the timer passes a preset point without another event, points are added to the drivers score and the counter and timer are zeroed out.

Event tracking and scoring is as follows. Event scoring system is automatically turned on when the vehicle reaches a preset speed. Each time the scoring system is turned on, the driver is allocated 100 points. Points will be deducted for drifting and weaving. Points will be added for staying in a lane for a preset time limit or making proper controlled lane changes. Event scores will be time stamped by the processor and stored in memory. During the driving period, the driver will be alerted to each event with a visual indicator on the display, an audible buzzer or tone, or in an alternate embodiment, with seat vibration. The driver can also be alerted when the driver's score exceeds certain driver adjustable thresholds. At the end of each driving period, a score total will be displayed to the driver and stored in memory. Previous stored scores can be recalled by drivers with the press of a button on the user interface.

In alternate embodiments, in-vehicle noise sensors, accelerometers, and sleep detection sensors also communicate with the user interface and contribute to scoring.

Those skilled in the art will appreciate the above-mentioned features and advantages of the invention together with other important aspects thereof upon reading the detailed description that follows in conjunction with the drawings provided.

### BRIEF DESCRIPTION OF DRAWINGS

The disclosed inventions will be described with reference to the accompanying drawings, which show important sample embodiments of the invention and which are incorporated in the specification hereof by reference, wherein:

FIG. 1A is a perspective diagram of a lane sensing driver scoring system in the exemplary embodiment of the present invention.

FIG. 1B is an elevation view of typical lane markings in the exemplary embodiment of the present invention.

FIG. 1C is an elevation view of a display and processing unit in the exemplary embodiment of the present invention.

FIG. 2 is a block diagram of the lane sensing driver scoring system in the exemplary embodiment of the present invention.

FIG. 3 is a block diagram of the sensor unit, the display and processor unit and the various components comprising them.

FIG. 4 is a optical configuration layout of the IR sensor system in the exemplary embodiment of the present invention.

FIG. 5 is a block diagram of a multiple sensor based driver scoring system in an alternate embodiment of the present invention.

FIG. 6 is a timing diagram showing series intervals, scoring intervals and event intervals in the exemplary embodiment of the present invention.

FIG. 7 is a block diagram of the data structure components of the scoring system in the exemplary embodiment of the present invention.

FIG. 8 is a data structure chart of the user table and the event table in the exemplary embodiment of the present invention.

FIG. 9 is a flowchart diagram of the scoring method of the exemplary embodiment of the present invention.

FIG. 10 is a flowchart diagram of an exemplary process to update a user table.

FIG. 11 is a set of flowchart diagrams describing exemplary reporting processes of the present invention.

FIG. 12 is a schematic diagram of the sensor unit circuit of the exemplary embodiment of the present invention.

### DETAILED DESCRIPTION OF EXEMPLARY EMBODIMENTS

The numerous innovative teachings of the present application will be described with particular reference to the presently preferred and exemplary embodiments (by way of example, and not of limitation). In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

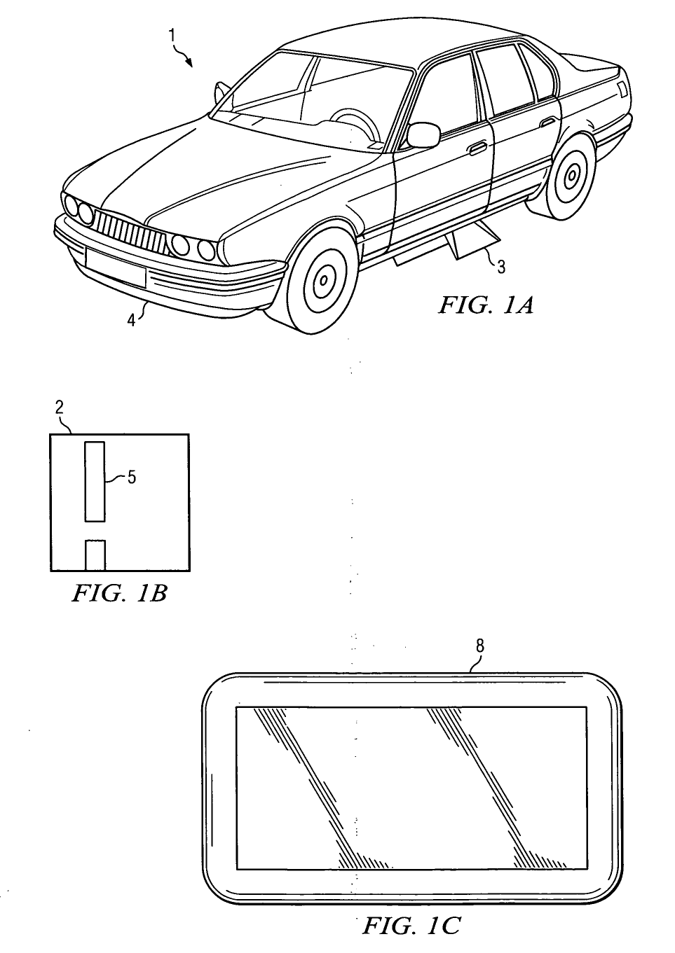

The present invention teaches a system for measuring automobile driver behavior and a set of methods for scoring driver behavior. The first exemplary embodiment measures driver behavior by detecting lane positions, lane changes and frequency of lane changes on roads while driving. FIG. 1 shows the concept of the first exemplary embodiment. Vehicle 1 is equipped with at least two lane sensor units 3, one on either side of the vehicle exterior mounted on the undercarriage approximately beneath the passenger and driver doors. Block 2 shows typical lane markers 5 painted onto the road surface below vehicle 1 which are scanned by lane sensors 3 to determine vehicle 1 lateral position on the road as a function of time.

In an alternate embodiment, vehicle 1 has lane sensor units 4 placed underneath the front bumper on both the driver's and passenger's side of vehicle 1. In an additional alternate embodiment, the sensor units may be spread out along the length of the underside of the car and encased in a plastic strip that adheres to the underside. Ultimately, the present invention is not limited to the position of the lane sensor units which may be placed in any number of locations along the vehicle exterior as long as the sensor units have vertical line of sight to the road surface and there is a lane marker on either side of the vehicle.

Inside vehicle 1, a display and processing unit 8 is located within view of the driver. Display and processing unit 8 is communicatively connected to the two lane sensors. Display and processing unit 8 is capable of storing a time series of events and analyzing the time series of events to determine driver scoring information. The driver scoring information calculated by display and processing unit 8 includes event score, total score, average score, and scoring trend of the driver. Display and processing unit 8 can display live scores for a current driving period or can display a history of scores sorted by driver. The driver scoring information may be visually displayed and audibly played by the display and processing unit 8 to alert the driver to proper or poor driver behavior.

Display and processing unit 8 may also store a time series of scores which may be recalled for use by entities other than the driver. For example, an insurance company may have a program to rate the driver behavior according to the scoring information and offer insurance premium discounts accordingly.

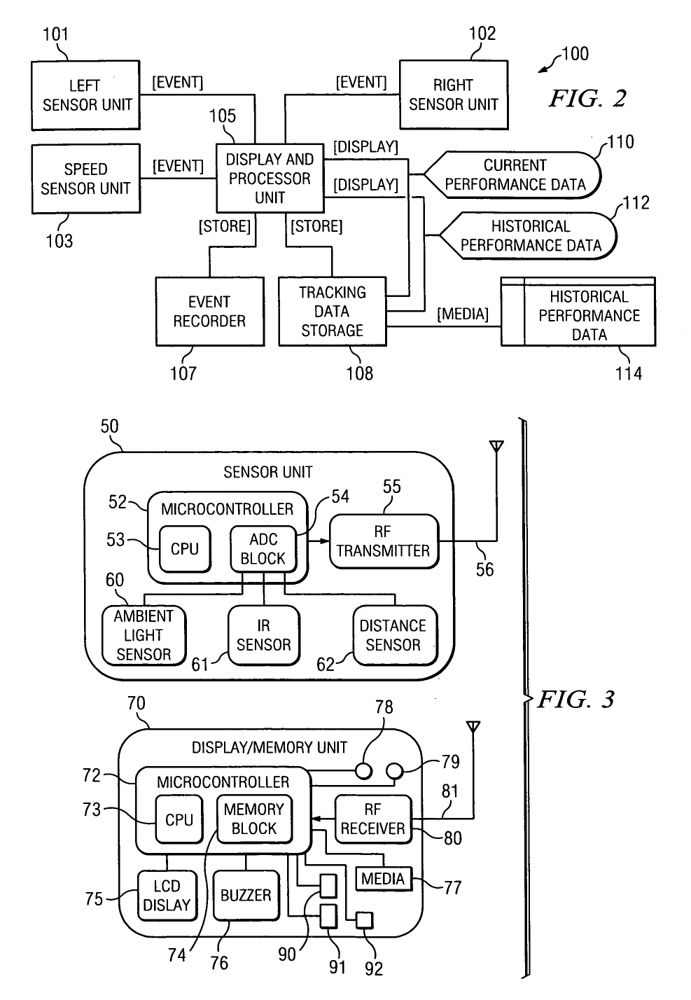

A somewhat more detailed system view of the exemplary embodiment is shown in the block diagram of FIG. 2. Driver scoring system 100 is comprised of left sensor unit 101, right sensor unit 102, and speed sensor 103, each connected to display and processor unit 105. Driver scoring system 100 also includes an event recorder application 107, tracking and data storage application 108, current performance dash display 110, historical performance dash display 112, and historical performance record 114 which are utilized by the display and processor unit 105.

Right sensor unit 102 and left sensor unit 101 detect and recognize driving events which are processed by display and processor unit 105. The driving events are recorded by event recorder application 107 which is a program operating on display and processor unit 105. The driver is alerted to events as they happen by either a visual or audible indicator on display and processor unit 105 or a combination of both. In an alternate embodiment, a seat vibrator further alerts the driver and can act as a deterrent to drowsiness. Tracking and data storage application 108, also a program operating on display and processor unit 105, is programmed to perform calculations on the recorded driving events to determine and store a time series score function. Display and processor unit 105 may show current performance data 110 incorporating data for the current driving period and historical performance data 112 incorporating data from multiple previous driving periods sortable by driver. Current performance data 110 includes event score, total score, and performance trends. Historical performance data 112 includes event scores, total scores, performance trends, and average scores. Display and processor unit 105 may also create a permanent record of historical performance data 114 on removable media. Examples of removable media include but are not limited to secure digital cards and USB flash drives.

FIG. 3 is yet a more detailed block diagram of a lane sensor unit 50 and a display and processing unit 70 of the exemplary embodiment of the present invention. Lane sensor unit 50 is comprised of microcontroller 52 having central processor CPU 53 and analog-to-digital conversion capability in ADC block 54; ambient light sensor 60 for sensing ambient light; IR sensor 61 for sensing road surface changes; distance sensor 62 for sensing the distance between the sensor unit and a road surface; RF transmitter 55 with RF antenna 56 for communicating messages to display and processing unit 70. Ambient light sensor 60, IR sensor 61, distance sensor 62, and RF transmitter 55 are connected to and in communications with microcontroller 52.

Display and processing unit 70 is comprised of at least a microcontroller 72 having a central processor CPU 73 and memory block 74 connected thereto for storing program code, storing event data and tracking scores; display device 75 connected to microcontroller 72 for displaying visual information related to events and scoring; audio device 76 connected to microcontroller 72 for communicating audible information related to events and scoring; LED 79 also connected to microcontroller 72 for indicating the sensor units are in communication with the display and processing unit; LED 78 connected to microcontroller 72 for indicating display and processing unit is powered on; RF receiver 80 connected to microcontroller 72 with RF antenna 81 for receiving messages from lane sensor unit 50; and a set of buttons 90, 91 and 92 also connected to microcontroller 72 for controlling the function of the unit.

Memory block 74 may comprise volatile and non-volatile memory. Additionally, display and processing unit 70 also includes a means of reading and writing removable storage media 77 such as a secure digital card drive or USB flash drive, the removable storage media 77 being connected to and controlled by microcontroller 72.

Additionally, the lane sensor unit 50 and display and processing unit 70 each have a physical serial interface (not shown) connected to and in communications with the microcontrollers for testing, for uploading programs, for downloading event and historical scoring information, and for a wired configuration if desired. In the wired configuration, sensor unit 50 and display and processing unit 70 are physically connected by serial communication lines in lieu of RF wireless communications using the RF transmitter 55 and RF receiver 80.

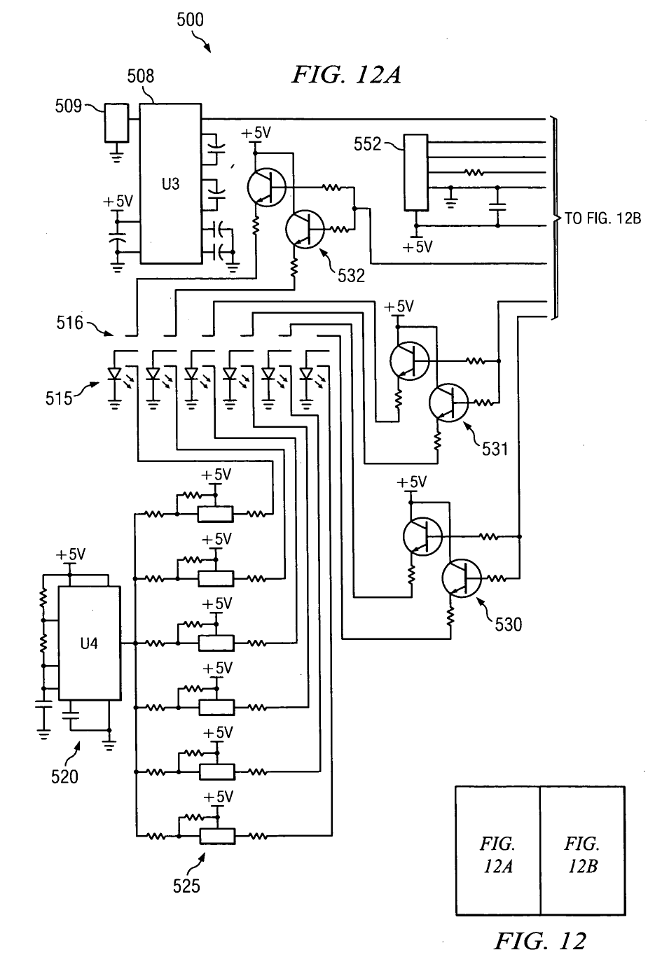

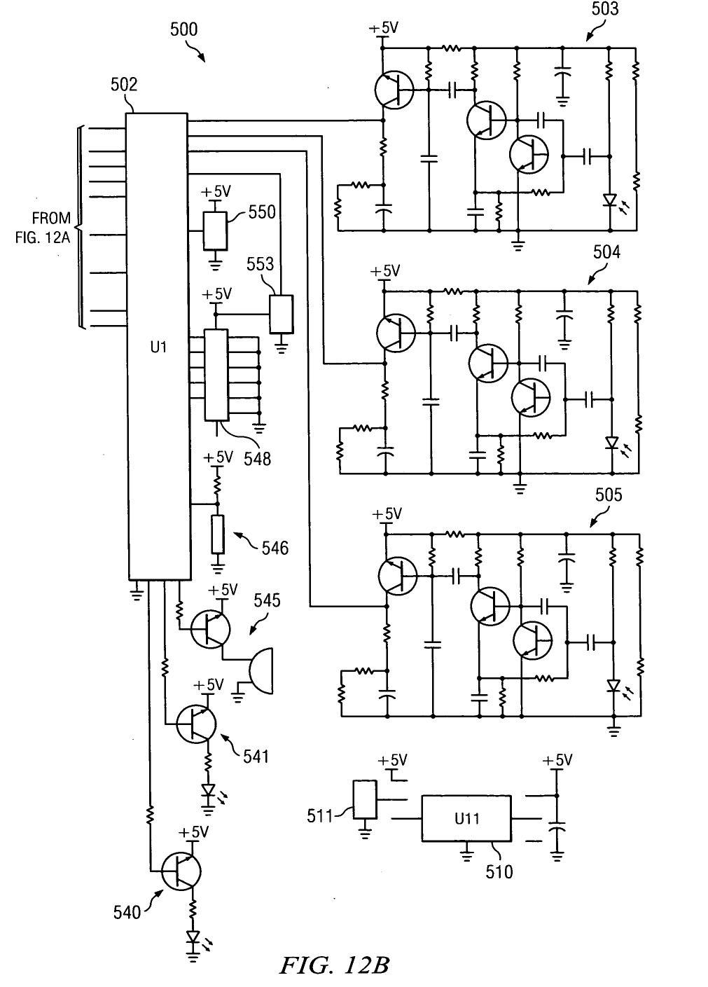

A preferred circuit 500 for implementing lane sensor unit 50 of FIG. 3 is shown in the schematic diagram of FIG. 12. Circuit 500 is comprised of microcontroller 502 and a set of subcircuits that perform various functions including infrared detectors 503, 504, and 505; power converter 510, serial communications RS232 chipset 508, set of infrared transmitter LEDs 515, first set of LED drivers 530, 531, and 532; infrared transmitter modulation circuit comprising a stable oscillator 520 generating a 38 kHz square wave signal and second set of LED drivers 525; powered detection indicator LED 540; lane detector indicator LED 541; buzzer 545; ambient light detector 546; and RF transmitter 548.

Additionally, circuit 500 contains a set of connectors to connect with external devices. 12V input connector 511 (J5) connects power from the vehicle to power circuit 500. Connector 553 (J2) connects distance sensor 62 to microcontroller 502. Connector 552 (J1) connects an external programmer to microcontroller 502. Connector 550 (J3) connects optional extra distance or light sensors for averaging the input distance or light value. Serial connector 509 (J4) connects an external computer to microcontroller 502 for programming and testing purposes.

First set of LED drivers 530, 531 and 532 are connected to microcontroller 502 and further connected to set of jumpers 516, so that microcontroller 502 may control infrared transmitter LEDs 515 if jumpers 516 connect pin 1 to pin 2 for each transmitter. Second set of LED drivers 525 are connected to a stable oscillator 520 and further connected to set of jumpers 516 so that infrared transmitter LEDs 515 may be driven by the 38 kHz square wave signal when jumpers 516 connect pin 2 to pin 3 for each transmitter. Infrared transmitter LEDs 515 have an option of being powered by microcontroller 502 or a fixed 38 KHz oscillator. Indicator LEDs 540 and 541 along with buzzer 545 are connected to and controlled by microcontroller 502 and are useful for indication of operational states of the sensor like “Power On” and “Lane Detected.” Ambient light detector 546 is connected to an onboard analog to digital converter (ADC) built in to microcontroller 502 and is comprised of a light dependent resistor M1 and fixed resistor R38 in a light dependent voltage divider configuration. RF transmitter 548 is connected to and controlled by microcontroller 502. RF transmitter 548 is used to communicate with display and processor unit 70. RS232 chipset 508 is connected to and in communications with microcontroller 502 and external devices through connector 509. Infrared detectors 503, 504 and 505 are identical to one another and are further comprised of photodetectors Rx1, Rx2 and Rx3 for detecting infrared light signals each connected to transistor amplifier circuits for amplifying the detected infrared light signals. The output of each transistor amplifier circuit is connected to the onboard ADC of microcontroller 502 so that microcontroller 502 may measure the detected and amplified light signal.

Microcontroller 502 is programmed to read and processes signals received from distance sensor 62, ambient light detector 546, and infrared detectors 503, 504 and 505 to decide if a lane marker is underneath the lane sensor unit. Additionally, if distance sensor 62 sends signals to microcontroller 502 that indicate very small distances between the sensor and the road surface, the microcontroller will process this to mean that distance sensor 62 is fouled with mud/slush etc. An alert and message of “Clean Sensors” will appear oh the display. The frequency modulation applied to infrared transmitters 515 allows for signal processing such as signal averaging or lock in detection to reduce the background noise and improve lane marker detection signal to noise ratio.

Microcontroller 502 is preferably CY8C21534 microcontroller from Cypress Semiconductor. RF modulator is part RFM-02S from HOPE RF Microelectronics. Distance sensor 62 may be the GP120 series distance sensor from Sharp Electronics. Infrared transmitter LEDs 515 may be part BPV10 from Vishay. Infrared receivers may be part TSAL5100 from Vishay. The light dependent resistor comprising ambient light sensor 546 is part TSL12S from TAOS. Buzzer 545 and LED indicators 540 and 541 are comprised of standard off the shelf components as known in the art and may alert the driver to a sensor malfunction. Power converter 510 is comprised of the LM1117 voltage regulator from National Semiconductor. The serial communications RS232 chipset 508 is part MAX232 from Maxim Integrated Products of Dallas Semiconductor. All transistors in circuit 500 may be general purpose PNP or NPN transistors as required such as the BC847NPN and BC857 PNP transistors from Fairchild Semiconductor.

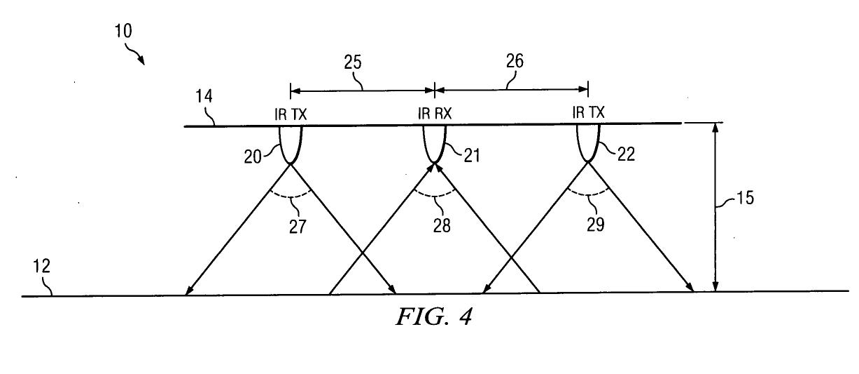

FIG. 4 shows the preferred optical configuration 10 of IR sensor 61. The configuration of FIG. 4 is repeated three times for IR sensor 61 to include the set of infrared transmitter LEDs 515 and infrared detectors 503, 504, and 505.

Infrared transmitter 20 and infrared transmitter 22 for transmitting IR light are positioned on lane marker sensor body 14 attached to a vehicle so that the infrared transmitters illuminate the road surface 12 with cone angles 27 and 29 of about 20 degrees each. Road surface 12 is a vertical distance 15 from the infrared transmitters 20 and 22.

An infrared receiver 21 for detecting IR light is located on sensor body 14 at a distance 25 from infrared transmitter 20 and a distance 26 from infrared transmitter 22. The field of view from which infrared light may be detected is indicated by cone angle 28 of about 40 degrees. Illumination from infrared transmitters 20 and 22 is reflected from road surface 12 and collected by infrared receiver 21.

Ambient radiation emanating from the road surface and from objects within the receiver cone angle may be collected by a set of infrared transmitters and receivers similar to optical configuration 10 to form the ambient light sensor 60. Alternatively, IR sensor 61 having optical configuration 10 may also be used to simultaneously sense ambient light.

Lane marker sensor unit 50 of the present invention has circuitry and firmware programs contained therein to detect changes in diffusely reflected IR light levels measured by infrared receiver 21 and using the detected changes to differentiate the character of road surface 12 in the presence of ambient radiation. In differentiating the character of the road surface 12, white lane markers typically painted onto road surface 12 may be detected as they fall within the cone angle 28.

Different road surfaces will reflect different percentages of IR light. For example, if road surface 12 within the cone angles 27 and 29 is unpainted dry asphalt, IR light will diffusely reflect from the unpainted dry asphalt into the infrared receiver 21 with a given average diffuse reflection coefficient. If the road surface 12 within the cone angles 27 and 29 changes to painted dry asphalt, the average diffuse reflection coefficient will generally increase from the unpainted dry asphalt and the infrared receiver 21 will typically collect more IR light in the cone angle 28 than from the unpainted dry asphalt surface. A change in received IR light signal may thus be used to detect changes in road surface 12 such as would be expected when the vehicle crosses a white lane marker.

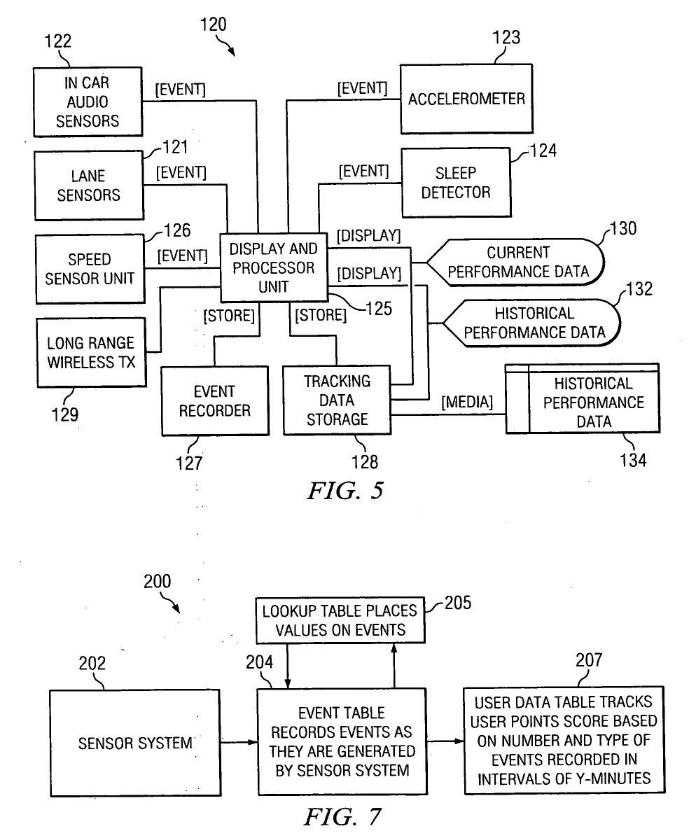

Other exemplary embodiments of the driver scoring system are conceived that utilize one or more behavioral sensors in addition to the lane sensors. FIG. 5 shows an alternate driver scoring system 120 with at least three additional classes of behavioral sensors that may be used in conjunction with the lane sensors. Alternate embodiments may include any number and permutations of the sensors in driver scoring system 120. Also the present invention is not intended to limit the types of sensors shown in FIG. 5. Other embodiments may be conceived utilizing a larger class of behavioral sensors and permutations thereof.

Driver scoring system 120 of FIG. 5 is comprised of a set of sensors including a set of lane sensors 121, in-vehicle audio level sensor 122 for sensing sound dB levels in the vehicle cabin, accelerometer 123 for sensing rapid changes in speed, sleep detector 124 for detecting driver behavior consistent with drowsiness, and speed sensor 126 for sensing speed, each connected to a display and processor unit 125. Driver scoring system 120 also has an event recorder application 127, tracking and data storage application 128, current performance display 130, historical performance display 132 and historical performance record 134 which are utilized by the display and processor unit 125.

The set of sensors in driver scoring system 120 detect and recognize behavioral events related to driving which are processed by display and processor unit 125. The behavioral events are recorded by event recorder application 127, a program operating on display and processor unit 125. The driver is alerted to events as they occur by audible, visual, vibration or any combination of indicators from display and processor unit 125. A tracking and data storage application 128, also a program operating on display and processor unit 125, is programmed to perform calculations on the recorded behavioral events to determine and store a time series score function. Display and processor unit 125 may show current performance data 130 incorporating data for the current driving period and historical performance data 132 incorporating data from multiple previous driving periods sortable by driver. Current performance data 130 includes event score, total score, and performance trends. Historical performance data 132 includes event scores, total scores, performance trends, and average scores. Display and processor unit 125 may also create a permanent record of historical performance data 134 on removable media.

In yet another embodiment of the present invention indicated in FIG. 5, the driver scoring system may include a long range wireless transmitter 129 for the real-time transmission of driver scoring data to a third party monitoring system. This aspect of the invention has many potential applications including, but not limited to, auto insurance monitoring services for evaluating discounted premiums, local government agencies requiring probationary monitoring of drivers previously convicted of driving offenses such as DUI, and driving schools having a driver scoring system as a part of the driving evaluation process. Additionally, the transmission of driver scoring data could used to monitor school bus drivers and public transportation operators.

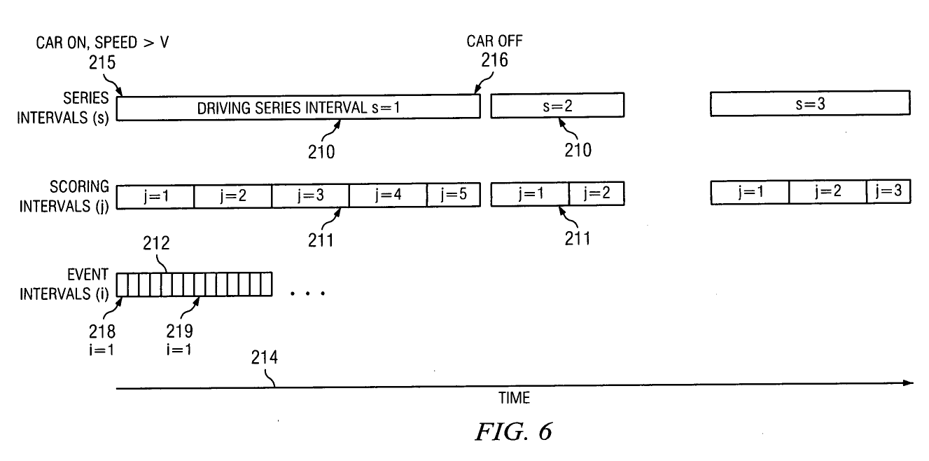

The scoring system operates using a set of time intervals as shown in FIG. 6 which is a one dimensional graph with time 214 increasing to the right. A set of series time intervals 210 are labeled sequentially s=1, 2, etc. One series time interval for each driving period is defined from the time 215 that the car is turned on and first exceeds an initial speed, V, until the time 216 that the car is turned off. A set of scoring intervals 211 are equally spaced in Y-minutes of time, labeled j=1, 2, etc. The index j starts from 1 for each series time interval. A set of event intervals 212 are equally spaced in N-second intervals of time, labeled i=1,2, etc. The index i starts from 1 for each scoring interval at times 218 and 219. In the exemplary embodiment, V has a default value of 20 kmph, Y has a default value of 10 minutes, and N has a default value of 3 seconds.

The scoring system uses a set of tables to store scoring information. FIG. 7 shows a block diagram of the data elements 200 comprising the sensor system 202, events table 204, lookup table 205, and user table 207. Sensor system 202 detects and recognizes events. Events are instances of poor or proper driving. For example, riding a lane line, straddling a lane line, multiple successive lane changes, and proper driving for a specific time interval detected by the sensors are all events. Events table 204 stores records of events as they are generated by the sensor system, one record for each event. User table 207 stores records of scoring totals. There is one record for each scoring interval. Lookup table 205 serves as a cross-reference and assigns a number of points to each event type that is reported by the sensor system.

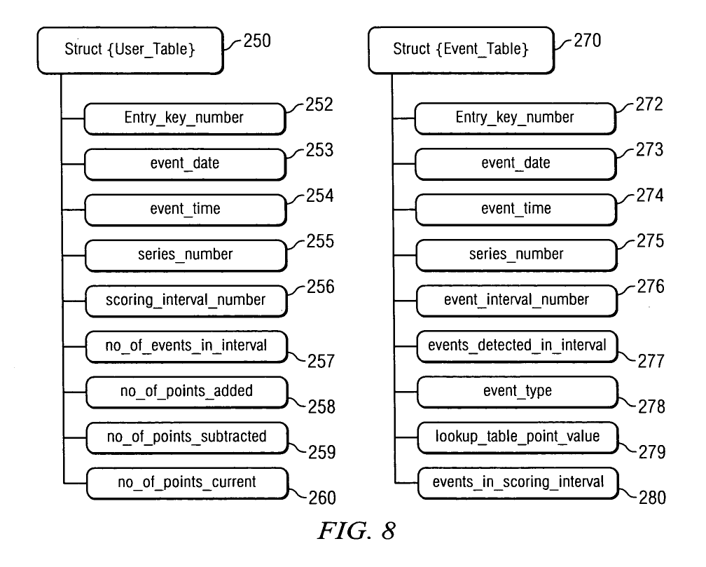

FIG. 8 shows the data structures for the user table 207 and the event table 204. User record structure 250, associated with user table 207, contains the fields entry_key_number 252, event_date 253, event_time 254, series_number (s) 255, scoring_interval_number (j) 256, no_of_events_in_interval 257, no_of_points_added 258, no_of_points_subtracted 259, and no_of_points_current 260. The field no_of_points_current 260 is the total accumulated points M over multiple scoring intervals in a given series interval.

In the simplest and normal situation, only one user table is required per scoring system. There may be multiple user tables per scoring system. One user table may be programmed for each valid user of the vehicle and identified by the field entry_key_number 252. Valid users are programmed directly into the display and processor unit and may have the additional feature of automatically looking up a valid user and user table based on the automobile key used for the automobile security system. If an automobile key cannot be used to look up a valid user, the driver may manually select the user using buttons provided on the display and processing unit.

Continuing with the description of FIG. 8, event record structure 270, associated with event table 204, has the fields entry_key_number 272, event_date 273, event_time 274, series_number (s) 275, event_interval_number (i) 276, events_detected_in_intervals 277, event_type 278, lookup_table_point_value (LTV) 279, and events_in_scoring_interval 280. Events_in_scoring_interval 280 is used to accumulate the total number of event records in a scoring interval and is initialized to zero when the event table is initialized.

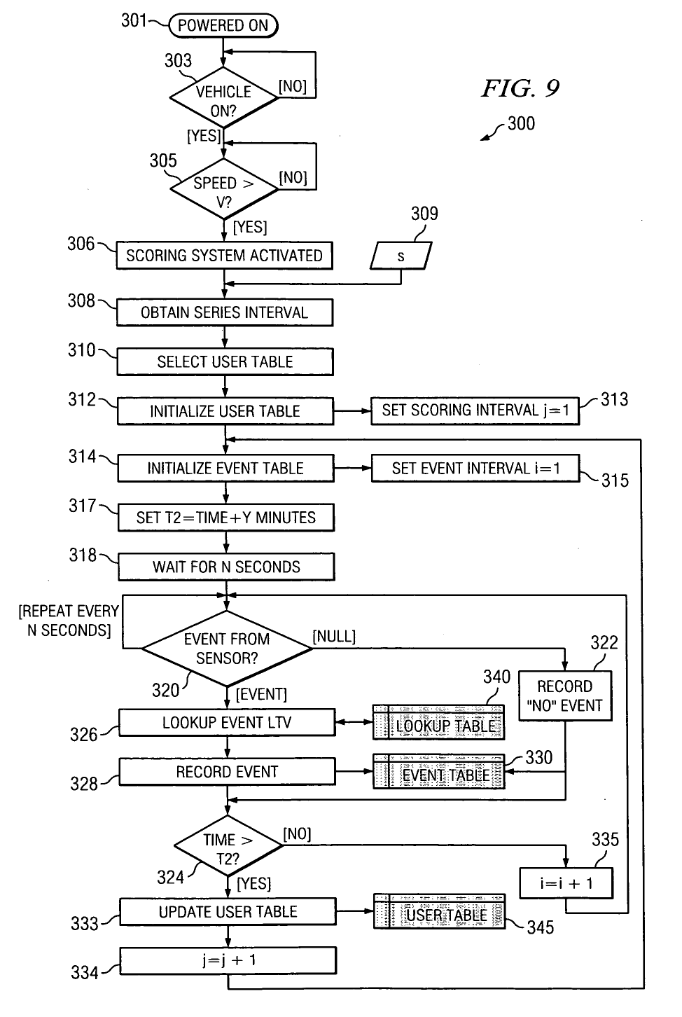

The scoring system uses a scoring process which is performed by the CPU of the display and processor unit as a set of programmed instructions kept in non-volatile memory. FIG. 9 shows a flowchart of the programmed instructions. Scoring process 300 begins when the display and processor unit powers on in step 301 after which the scoring system waits until the vehicle is turned on in step 303 and then monitors the speed of the vehicle in step 305. Once the vehicle moves forward at a speed greater than a predefined threshold speed V, the scoring system is activated in step 306.

Scoring process 300 then continues in step 308 to set the series interval number s by reading a series interval number 309 from memory and incrementing it by one, the new series interval number being then stored back to memory. A user table 345 is then selected in step 310, the selection being based on obtaining a driver ID by matching the driver's wireless ignition key, user input from the display and processor unit, or by using a default driver ID. The selected user table 345 is then initialized in step 312 according to table 1. M is initialized to a programmable preset number MO, the preset number being 100 in the exemplary embodiment. The event table 330 is then initialized in step 314 according to table 2. The scoring process completes the initialization by setting a running scoring interval index j to j=1 in step 313 and by setting a running event interval index i to i=1 in step 315.

TABLE 1
User Table Initialization

| Field | Value |
|---|---|
| entry_key_number | Driver ID |
| event_date | Current Date |
| Event_time | Current Time |
| Series_number | s |
| scoring_interval_number | 0 |
| no_of_events_in_interval | 0 |
| no_of_points_added | 0 |
| no_of_points_subtracted | 0 |
| no_of_points_current | M0 |

In step 317 a time T2 is defined as T2=(current time)+(Y minutes), where Y is the preset scoring interval time. The scoring process then waits for N seconds in step 318, N being the preset event interval time. Step 320 then checks if an event has occurred in the previous N seconds. If no event has occurred, then in step 322, event table 330 is updated according to Table 3 and the process continues to step 324.

If in step 320, an event has occurred the process continues with step 326 wherein the event points value (LTV) are looked up in lookup table 340 according to the event type returned from the sensor system. In step 328 the event is recorded in event table 330 according to the values shown in Table 4.

TABLE 2
Event Table record initialization

| Field | Value |
|---|---|
| entry_key_number | Driver ID |
| event_date | Current Date |
| event_time | Current Time |
| series_number | s |
| event_interval_number | 0 |
| events_detected_in_interval | 0 |
| event_type | null |
| lookup_table_point_value | null |
| events_in_score_interval | 0 |

TABLE 3
Event Table record for case of “no” events

| Field | Value |
|---|---|
| entry_key_number | Driver ID |
| event_date | Current Date |
| event_time | Current Time |
| series_number | s |
| event_interval_number | i |
| events_detected_in_interval | 0 |
| event_type | null |
| lookup_table_point_value | null |
| events_in_score_interval | 0 |

TABLE 4
Event table record after an event has occurred

| Field | Value |
|---|---|
| entry_key_number | Driver ID |
| event_date | Current Date |
| event_time | Current Time |
| series_number | s |
| event_interval_number | i |
| events_detected_in_interval | 1 |
| event_type | [type value from sensor] |
| lookup_table_point_value | LTV |
| events_in_score_interval | [previous value] + 1 |

If multiple events occur in an event time interval of N-seconds, then events_detected_in_interval is set to the number of events detected and the events_in_score_interval is set to the previous value added to the number of events detected. After step 328 or step 322 is completed step 324 is performed to check if the scoring interval has elapsed or not. If the current time is less than or equal to T2 then the scoring interval has not elapsed and the process continues with step 335, otherwise the process continues with step 333. In step 335, the event interval index is incremented by one and then the step 320 is repeated after waiting for N seconds.

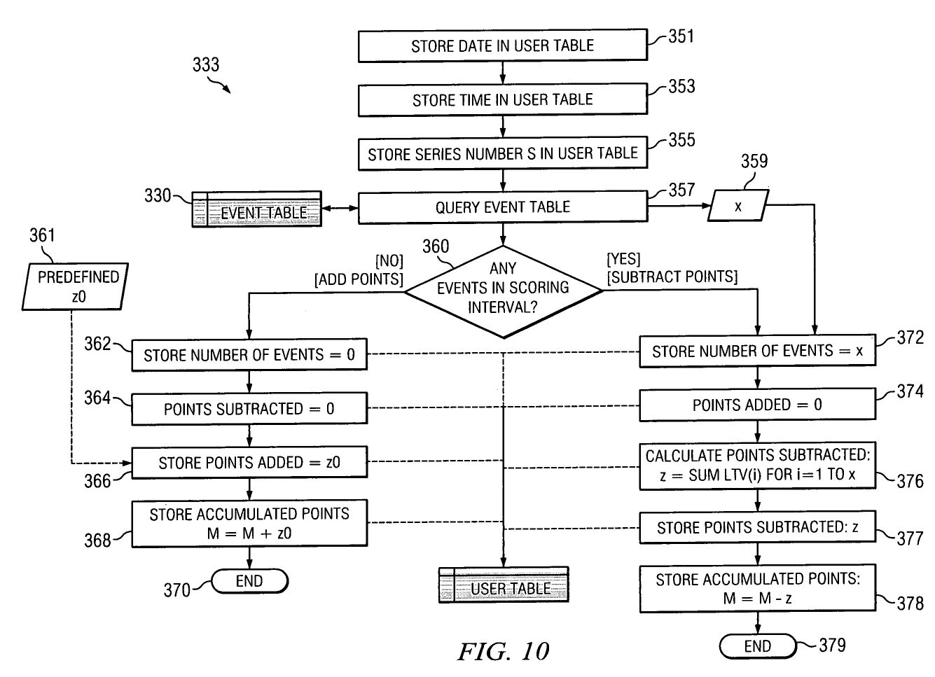

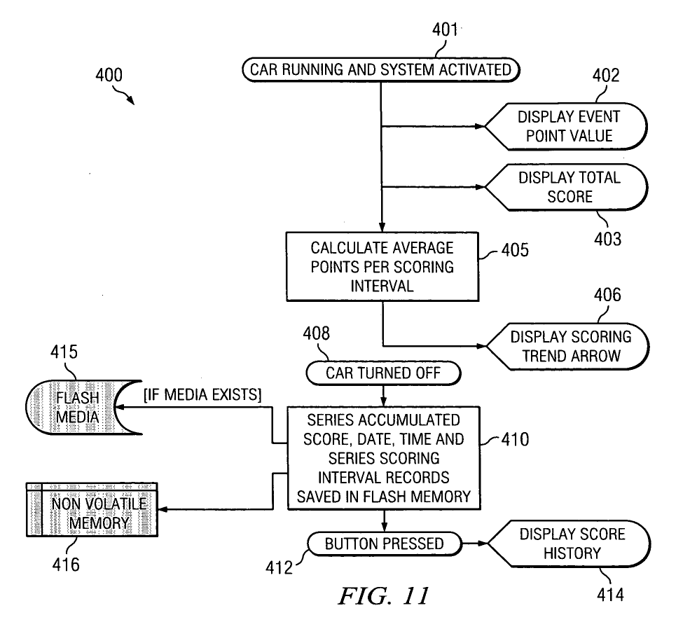

In process 333, the user table 345 is updated according to a method that will be described in relation to FIG. 10. Step 334 then increments the scoring interval index by one and the process is repeated beginning at step 314 including step 315. The scoring process 300 continues to operate until the car is stopped and turned off, in which a reporting process 400 shown in FIG. 11 is performed by the display and processor unit.

Process 333 to update the user table is shown in FIG. 10. Step 351 stores the date in event_date field 253 of user table 345. Step 353 stores the current time in the event_time field 254 of the user table 345. Step 355 stores the current series number s in series_number field 255 in user table 345. Then in step 357 event table 330 is queried to obtain the number of events 359 accumulated in the Y-minute scoring interval. The number of events being designated by the variable x. Step 360 determines if any events occurred during the current scoring interval and adds or subtracts points accordingly. If there are no events during the current scoring interval, the driver is awarded positive points which are added to his score. If at least one event has occurred during the current scoring interval, points are subtracted from the driver's score.

In the case there are no events during the current scoring interval, the user record is updated according to Table 5 and steps 362, 364, 366 and 368. Step 362 sets the number of events to zero. Step 364 sets the number of points subtracted to zero. Step 366 records the number of points added which is equal to z0, a programmable predefined constant 361. Step 368 adds to the current number of points M the value of z0 to obtain and record the new current number of points. The process 333 ends at step 370.

TABLE 5
User Table record for “no” events in scoring interval

| Field | Value |
|---|---|
| entry_key_number | Driver ID |
| event_date | Current Date |
| event_time | Current Time |
| series_number | s |
| scoring_interval_number | j |
| no_of_events_in_interval | 0 |
| No_of_points_added | z0 |
| No_of_points_subtracted | 0 |
| No_of_points_current | M + z0 |

In the case there are some events during the current scoring interval, the user record is updated according to Table 6 and steps 372, 374, 376, 377 and 378. Step 372 sets the number of events in user table 345 to the value of x. Step 374 sets the number of points added to zero. Step 376 calculates the number of points subtracted which is equal to z, wherein z is computed as the sum of all the LTV values found in the lookup_table_point_value field 279 for event intervals recorded in event table 330 during the current scoring interval. Step 377 stores the points subtracted z in user table 345. Step 378 subtracts from the current number of points M the value of z to obtain and record the new current number of points. The process 333 ends at step 379.

TABLE 6
User Table record for x events in scoring interval

| Field | Value |
|---|---|
| entry_key_number | Driver ID |
| event_date | Current Date |
| event_time | Current Time |
| series_number | s |
| scoring_interval_number | j |
| no_of_events_in_interval | x |
| No_of_points_added | 0 |
| No_of_points_subtracted | z |
| No_of_points_current | M − z |

FIG. 11 shows a method of the exemplary embodiment for reporting score results during a driving period. In Step 401 the car is running above a preset speed and the system is activated. While the car is still running, indicating the driving period may continue, certain scores can be displayed. Step 402 displays the point value of the last event detected, either z0 (if points were added) or z (if points were subtracted). Step 403 displays the accumulated series score M_series, or total score, which is the value of the no_of_points_current field 260 in the most recent scoring interval record. During a driving period, the driver will be alerted either through an audible alert or a visual alert if the driver's total score exceeds a preset threshold. Thresholds can be set at high values as goals to strive for and at low values to warn drivers of repeated poor driving performance. Step 405 calculates the average points per scoring interval z_ave which is the computed as

z_{—}ave=(M_series−M0)/E

Where M0 is the initial points total and E is the value of the no_of_events_in_interval field 257 in the most recent scoring interval record. In step 406, the average points per scoring interval is used by the system to calculate and display a scoring trend. The scoring trend is indicated by an upward arrow or a downward arrow on the display. The scoring trend is updated after each event is detected. A point adding event results in the up arrow and a point subtracting event the down arrow. If the driver maintains a trend either positive or negative over a preset threshold time interval, the driver will be commended or warned via the display unit. The threshold is preset by the user and the alert can be audible, visual, vibration, or any combination thereof.

The car is turned off in step 408 of FIG. 11 after which in step 410 M_series, z_ave, date, time and all scoring interval records in the current series are saved in removable media 415 if it exists and in non-volatile onboard memory 416. This history data, along with previous scores saved from previous driving periods, is used to calculate an average score of the driver.

In step 412, a button may be pressed on the display and processing unit at any time to display the latest event score, the total score, the average score, or the scoring trend. Step 414 displays the value selected. Up and down buttons on the display and processing unit may be depressed to scroll through the values of different drivers.

Events are recognized by the sensor units by processing detected data and applying event recognition rules. Examples of lane event recognition rules are as follows with the caveat that no lane recognition occurs unless the vehicle is traveling above a predefined speed. If lane markers are detected several times in the same sensor on one side of the car without appearing in the second sensor, the event detected is “Riding a line.” If lane markers are detected by a first sensor on one side of the car but is not detected again by either sensor for a pre-set period of time, the event detected is “Straddling a line.” If lane markers are detected by a first sensor on one side of the car, then detected by the second sensor on the other side of the car and this is repeated in rapid succession, the event is registered as “Traffic weaving.”

It will be appreciated by those skilled in the art that changes could be made to the exemplary embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A system for scoring and alerting driver behavior by counting deviations between marked lanes on a road surface comprising:
a vehicle driven by a driver above a first speed, wherein the vehicle is flanked by the marked lanes;
a first sensor unit mounted to a first lateral side of the vehicle and a second sensor unit mounted to a second lateral side of the vehicle, wherein the first sensor unit and the second sensor unit have a vertical line of sight to the road surface;
a controller in communicative connection with the first sensor unit and the second sensor unit; wherein the controller comprises a display screen, a set of buttons, a set of LEDs, and an audio device;
the controller further comprises a processor connected to a data storage;
a set of programmed instructions running on the processor, for calculating an event score, a total score, an average score, and a scoring trend of the driver;
wherein at least one of the audio device and the display screen provides an alert to the driver if the total score exceeds a preset threshold; and,
wherein the display screen displays at least one of the event score, the total score, the average score, and the scoring trend.

2. The system for scoring and alerting driver behavior of claim 1 wherein at least one of the audio device and the display screen provides an alert to the driver if the scoring trend exceeds a preset threshold.

3. The system for scoring and alerting driver behavior of claim 1 wherein the controller further comprises an RF receiver to receive wireless signals from the first sensor unit and the second sensor unit.

4. The system for scoring and alerting driver behavior of claim 1 wherein the controller is connected to the first sensor unit by a first set of wires and the controller is connected to the second sensor unit by a second set of wires.

5. The system for scoring and alerting driver behavior of claim 1 wherein the total score is increased when no deviations have been counted during a first time interval.

6. The system for scoring and alerting driver behavior of claim 1 wherein the total score is reduced when at least one deviation is counted during a first time interval.

7. The system for scoring and alerting driver behavior of claim 1 wherein the scoring trend is displayed on the display screen in a first direction when no deviations have been counted during a first time interval.

8. The system for scoring and alerting driver behavior of claim 1 wherein the scoring trend is displayed on the display screen in a second direction when at least one deviation has been counted.

9. The system for scoring and alerting driver behavior of claim 1 wherein a history of scores is saved in the data storage and the history of scores is displayed on the display screen.

10. The system for scoring and alerting driver behavior of claim 1 wherein a history of scores is saved in the data storage and the data storage is connected to a removable media.

11. The system for scoring and alerting driver behavior of claim 1 wherein the controller further includes a wireless transmitter.

12. The system for scoring and alerting driver behavior of claim 1 further comprising:
an audio level sensor connected to the controller;
an accelerometer connected to the controller; and,
a sleep detector connected to the controller.

13. A driver scoring and lane changing detection system comprising:
a first sensor unit and a second sensor unit mounted on a vehicle, where the vehicle has an interior and travels at a first speed;
an interface unit connected to the first sensor unit and connected to the second sensor unit, where the interface unit is mounted in the interior;
the interface unit further comprises a controller and a display screen;
the interface unit receiving signals from the first sensor unit and the second sensor unit when the first sensor unit and the second sensor unit detect a lane change; and,
the interface unit displaying a score when calculated by the controller.

14. The driver scoring and lane changing detection system of claim 13 wherein the first sensor unit and the second sensor unit each comprise:
a microcontroller having a processor and an analog-to-digital converter;
an ambient light sensor connected to the microcontroller;
an infrared sensor connected to the microcontroller;
a distance sensor connected to the microcontroller; and,
a remote frequency transmitter connected to the microcontroller.

15. The driver scoring and lane changing detection system of claim 14 wherein the interface unit displays a “Clean Sensors” message when the distance sensor detects a small distance.

16. The driver scoring and lane changing detection system of claim 13 wherein the interface unit further comprises:
a set of LEDs connected to the controller;
a set of buttons connected to the controller;
an audio device connected to the controller;
a remote frequency receiver connected to the controller;
a removable memory port connected to the controller; and,
wherein the controller includes a processor and data storage.

17. The driver scoring and lane changing detection system of claim 13 wherein the interface unit further comprises a long distance wireless transmitter.

18. A method for scoring and reporting driver performance comprising the steps of:
providing a set of sensor units mounted to a vehicle, where the vehicle has a driver and the vehicle travels on a road surface having marked lanes;
providing a processing unit connected to the set of sensor units and mounted to the vehicle within reach of the driver, wherein the processing unit comprises a display screen connected to a controller and a data storage connected to the controller;
powering on the processing unit and powering on the vehicle;
accelerating the vehicle to a minimum speed;
receiving signals from the set of sensor units;
processing the signals and determining impact on scoring driver performance;
adjusting a driver performance score up or down based on the signals received;
presenting the driver performance score on the display screen;
stopping the vehicle;
calculating a total score and an average score from the driver performance score;
saving the total score and the average score in the data storage; and,
reporting driver performance by scrolling through the saved total scores and the saved average scores presented on the display screen.

19. The method for scoring and reporting driver performance of claim 18 where the processing unit further includes a data port and the method further includes the step of:
downloading saved total scores and the saved average scores to an external drive connected to the data port.

20. The method for scoring and reporting driver performance of claim 18 where the processing unit further includes a long distance wireless transmitter and the method further includes the steps of:
transmitting the driver performance score in real time to a remote monitoring station; and,
transmitting saved total scores and the saved average scores to the remote monitoring station.

21. A method for scoring and reporting driver performance comprising the steps of:
providing a set of sensor units mounted to a vehicle, where the vehicle has a driver and the vehicle travels on a road surface having marked lanes;
providing a processing unit connected to the set of sensor units and mounted to the vehicle within reach of the driver, wherein the processing unit comprises a display screen connected to a controller and a data storage connected to the controller;
powering on the processing unit and powering on the vehicle;
accelerating the vehicle to a minimum speed;
incrementing a series interval number stored in the data storage;
selecting and initializing a user table;
setting a scoring interval counter;
initializing an event table;
setting an event interval counter;
setting a scoring interval time to a preset value;
receiving signals from the set of sensor units for a preset event interval duration;
determining if signals received during the event interval duration create an event;
determining the number of events occurring during the event interval duration;
calculating a driver performance score based on the presence or omission of events during the event interval duration;
updating the user table; and,
reporting the driver performance score the display screen.

22. The method for scoring and reporting driver performance of claim 21 wherein the processing unit further includes a data port and the method further includes the step of:
downloading the driver performance score to an external drive connected to the data port.

23. The method for scoring and reporting driver performance of claim 21 wherein the processing unit further includes a wireless transmitter and the method further includes the step of:
transmitting the driver performance score in real time to a remote monitoring station.
